(19) United States
(12) Patent Application Publication
(10) Pub. No.: US 2012/0198366 A1
(43) Pub. Date: Aug. 2, 2012

(54) FUEL PRICE DATA DISPLAY

(75) Inventors: Ray Corcoran, Manchester (GB); Jonathan West, Manchester (GB)

(73) Assignee: KNOWLEDGE SUPPORT SYSTEMS LTD., Manchester (GB)

(21) Appl. No.: 13/016,378

(22) Filed: Jan. 28, 2011

(51) Int. Cl. G06F 3/048; G06F 15/16

(52) U.S. Cl. 715/763; 709/203; 715/781

(57) ABSTRACT

A computer-implemented method of displaying fuel price data to a user, the method being implemented in a computer comprising a memory in communication with a processor. The method comprises storing, in the memory, a plurality of fuel price data items, each fuel price data item being associated with at least one product and at least one retail fuel location and receiving, as input to the processor, configuration data associated with the user, the configuration data indicating fuel price data to be displayed to the user. The fuel price data items are processed, by the processor, and the configuration data to determine the fuel price data and the fuel price data is displayed, on a display device coupled to the computer, based upon the configuration data.

### TECHNICAL FIELD

The present invention relates to display of fuel price data to a user.

### BACKGROUND OF THE INVENTION

In many industries, commercial organisations have to determine prices at which their products are to be sold. Determination of such prices will need to take into account various factors. For example, a particular commercial organisation may wish to ensure that its prices are within a predetermined limit of a particular competitor's prices. Similarly, a commercial organisation may wish to ensure that a particular constraint is applied such that prices of different products sold by that organisation have a predetermined relationship with one another.

A particular industry in which prices need to be determined is the fuel industry. In particular, it is necessary to determine prices at which fuel is to be sold at retail fuel sites. The price charged by a particular retail fuel site, will be determined by a number of different parameters. For example, prices charged by the retail fuel site's competitors are likely to need to be taken into account, as are prices of various other products sold by the retail fuel site. Typically, a plurality of retail fuel sites operate in a particular region, and prices charged by different retail fuel sites in a particular region will routinely need to be taken into account. Additionally, prices charged in different regions in associated retail fuel sites may also need to be taken into account.

Traditionally, prices at which retail fuel sites sell fuel have been determined by skilled analysts who have mentally collated and processed data representing various parameters which need to be taken into account. Having carried out this processing, analysts can typically determine pricing, often convening at a meeting at which a plurality of pricing analysts make various strategy decisions.

More recently, automated systems for determining retail fuel prices have been used. In these automated systems data required for determining pricing is collected and provided to a pricing system which is often located remotely from the retail site. The pricing system uses the provided data together with other information to determine information useful for optimising fuel prices at the retail site. The other information may include a desired pricing strategy such as pricing that optimises sales volumes or that optimises retail site profit. The information generated by the pricing system generally takes the form of recommended pricing for fuels that satisfies the desired pricing strategy, but may also include other useful information such as reports and predictions of competitor prices. There remains a need for improvements in pricing systems and methods.

### SUMMARY

It is an object of the invention to provide improvements in systems and methods for displaying fuel price data to users of pricing systems.

According to a first aspect of the invention there is provided a computer-implemented method of displaying fuel price data to a user, the method being implemented in a computer comprising a memory in communication with a processor. The method comprises storing, in the memory, a plurality of fuel price data items, each fuel price data item being associated with at least one product and at least one retail fuel location; receiving, as input to the processor, configuration data associated with said user, said configuration data indicating fuel price data to be displayed to said user; processing, by the processor, said fuel price data items and said configuration data to determine said fuel price data; and displaying, on a display device coupled to said computer, said fuel price data based upon said configuration data.

In this way, fuel price data that is displayed to a particular user can be configured specifically to the requirements of the particular user and the fuel price data can thereby be made more relevant, useful or easily understood for that particular user.

The configuration data may comprise data indicating layout of the fuel price data to the user. For example, the configuration data may comprise data indicating a display area in which different fuel price data items are to be displayed. Additionally, or alternatively, the configuration data may comprise data indicating an order in which fuel price data items are to be displayed within a particular display area.

The configuration data may additionally or alternatively comprise data indicating data items to be displayed to the user. In this way, only fuel price data that is relevant to a particular user is displayed to that user, whilst fuel price data items that are not relevant to the particular user are not displayed. Displaying only relevant fuel price data based upon configuration data associated with different users therefore improves fuel price data display.

Processing the fuel price data items and the configuration data to determine the fuel price data may comprise identifying fuel price data to be displayed based upon the configuration data and processing the fuel price data items to determine a value of the fuel price data to be displayed. That is, fuel price data items that are to be displayed may be determined and values for those fuel price data items that are to be displayed may be determined. Some data requires processing to determine values of the data, and in this way data that is not to be displayed is not unnecessarily determined.

The displaying may comprise displaying a graphical user interface comprising a plurality of graphical user interface regions, and the configuration data may determine regions in which respective fuel price data is displayed.

Determining fuel price data may comprise selecting at least one of the plurality of fuel price data items. In general, only a subset of the fuel price data items are relevant for a user and as such only a subset of the fuel price data items may be selected.

The method may further comprise storing, in the memory, the configuration data associated with the user.

The configuration data associated with the user may be generated by: displaying a plurality of layout indicators, each layout indicator corresponding to one of the fuel price data items; receiving input indicating layout of the layout indicators; and generating the configuration data based upon the input.

The method may further comprise: displaying a configuration graphical user interface, the configuration graphical user interface comprising a plurality of configuration regions, each configuration region corresponding to one of a plurality of graphical user interface regions for displaying the fuel price data. Receiving input indicating layout of the fuel price indicators may comprise receiving input caused to arrange at least some of the layout indicators into at least one of the plurality of configuration regions. That is, a graphical user interface may be used in the generation of the configuration data, the graphical user interface having regions that correspond to regions within a graphical user interface in which the fuel price data is displayed. In this way, users can configure the user interface to suit their particular requirements.

Each of the plurality of configuration regions and each of the plurality of layout indicators may have an associated property, the property indicating relationships between the layout indicators and the configuration regions. The property may be a color. The relationship may be a relationship indicating that a fuel price data item associated with the layout indicator can be displayed in a graphical user interface region associated with the configuration region. For example, each of the configuration regions and layout indicators may have an associated color and layout indicators may be dragged and dropped into only those configuration regions having the same color. Layout indicators and configuration regions may have the same color if and only if the fuel price data item associated with the layout indicator can be displayed in the graphical user interface region associated with the configuration region.

Aspects of the invention can be implemented in any convenient form. For example computer programs may be provided to carry out the methods described herein. Such computer programs may be carried on appropriate computer readable media which term includes appropriate non-transient tangible storage devices (e.g. discs). Aspects of the invention can also be implemented by way of appropriately programmed computers and other apparatus.

### BRIEF DESCRIPTION OF THE DRAWINGS

Embodiments of the invention will now be described, by way of example, with reference to the accompanying drawings, in which:

FIG. 1 is a schematic illustration of part of a network of associated retail fuel sites in communication with a pricing system;

FIG. 2 is a schematic illustration of the pricing system of FIG. 1;

FIG. 2A is a schematic functional block diagram of part of the pricing system of FIG. 1;

FIG. 3 is a schematic illustration showing a computer associated with the pricing system of FIG. 2 in further detail;

FIG. 4 is a screen shot of a graphical user interface suitable for providing data to the data engine of FIG. 2;

FIG. 5 is a screenshot of a pricing page for displaying information to a user;

FIG. 6 is a screenshot showing data that may be displayed as part of a pricing page such as the pricing page of FIG. 5;

FIG. 7 shows part of the screenshot of FIG. 5 in more detail;

FIG. 8 is a screen shot of a pricing page configuration page; and

FIG. 9 is an entity diagram of a database suitable for storing and managing data to be displayed as part of the pricing page of FIG. 5.

### DETAILED DESCRIPTION

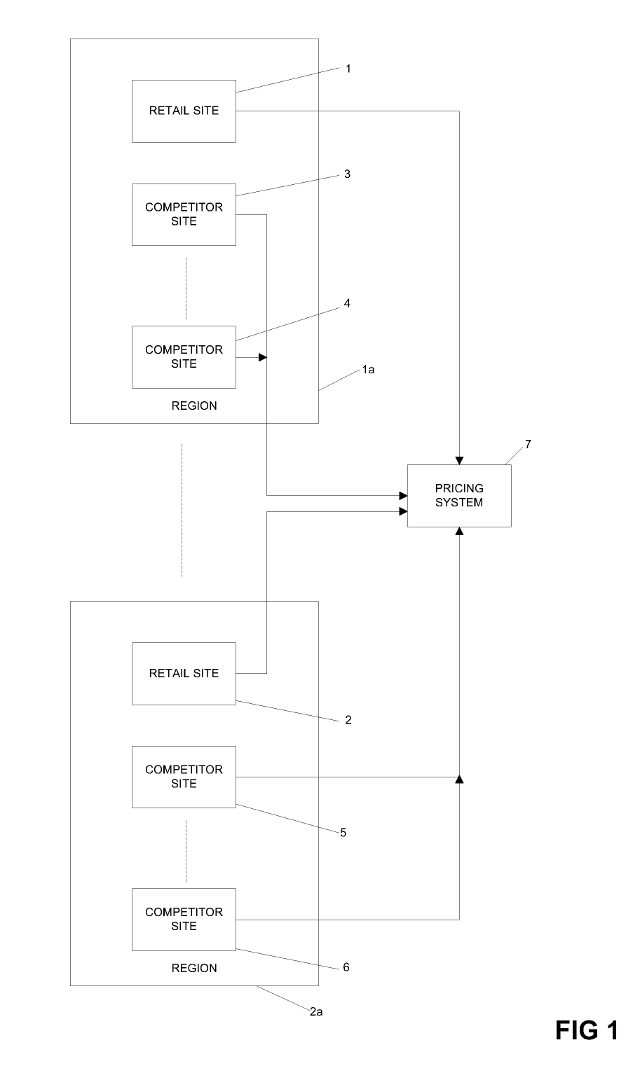

Referring first to FIG. 1 part of a network of associated retail fuel sites, 1, 2 is illustrated. Each of the associated retail fuel sites may be, for example, owned or operated by a single commercial entity, or may be supplied by a particular fuel supplier. Each of the associated retail fuel sites 1, 2 has an associated region 1a, 2a which defines a geographical area in which competitor retail sites 3, 4, 5, 6 are considered to be direct competitors. That is, competitor sites 3, 4 which lie in region 1a are direct competitors of the first associated retail site 1 and competitor sites 5, 6 which lie in region 2a are direct competitors of the second associated retail site 2 such that sales of sites lying in region 1a affect sales of other sites lying in region 1a and sales of sites lying in region 2a affect sales of other sites lying in region 2a. It will be appreciated that a wider area such as a country will generally be divided into a plurality of regions in which retail sites compete with competitor sites. Regions may be selected based upon a geographical region such as an area surrounding a city or may be selected based upon other factors that determine competing sites such as sites located along a particular highway.

Associated retail fuel sites 1, 2 in the network of associated retail fuel sites may further be arranged in networks indicating groups of associated retail fuel sites that share a common pricing strategy such as retail fuel sites located at motorway service stations or retail fuel sites located in urban or rural areas. Additionally, associated retail fuel sites may be operated under various contract types and retail fuel sites operating under particular contract types may also be arranged into networks. Examples of contract types under which retail fuel sites may operate may include “company owned, company operated”, “company owned, franchisee operated”, “dealer owned, dealer operated” and “company owned, dealer operated”. The associated retail fuel sites and competitor retail fuel sites, networks and regions are used to construct a model defining interrelationships between associated retail fuel sites and competitor retail fuel sites. Where changes to the networks and regions subsequently occur, the model defining interrelationships between the sites is updated to reflect the changes.

A pricing system 7 is arranged to receive various data including data associated with each of the associated retail sites 1, 2 and data associated with competitor sites 3, 4, 5, 6. The pricing system 7 is arranged to process the received data and to generate various output data, in particular an optimal pricing strategy for each of the products at each of the associated retail sites 1, 2 based upon the provided information.

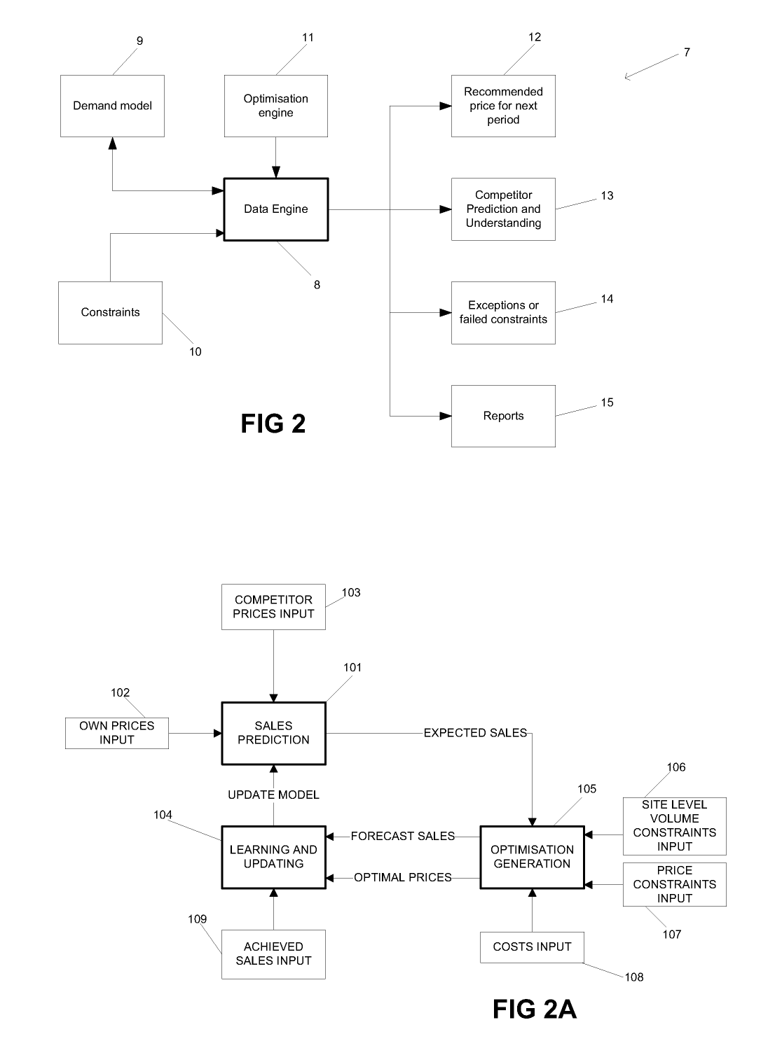

FIG. 2 shows operation of the pricing system 7 of FIG. 1 in more detail. It can be seen that the pricing system 7 takes various data as input, and generates various data as output as described above. Specifically, a data engine 8 takes as input a demand model 9 and constraints 10 and uses an optimisation engine 11. The demand model 9 forecasts sales volume for each product by site and time period. The demand model 9 uses past sales history at each site together with site prices and competitor site prices as well as elasticity values indicating sensitivity of customers to price changes for each product at each associated retail site 1, 2 and time period. The elasticity values provide an estimate of how demand for a particular product is likely to vary in response to price changes, either by an associated retail site 1, 2 or a competitor site 3, 4, 5, 6, and may be determined in an offline process using linear or non-linear regression modelling techniques based upon historic sales and price data. For example, stepwise or ridge regression may be used which are effective techniques for modelling historic price data which is generally highly correlated.

The retail site data and competitor site data may be provided to the pricing system 7 using a data link which automatically provides retail site data to the pricing system 7, for example at the end of each day. Competitor data is collected by the associated retail site 1, 2 and provided to the pricing system 7 in any convenient way, for example by using the same data link as used to provide retail site data or alternatively using mobile computing devices which are used by operatives to collect the competitor data from the competitor site and which provide the competitor data to the pricing system 7 over wireless telecommunications. Alternatively, data may be provided in any convenient way. An example user interface suitable for inputting site and competitor prices is described below with reference to FIG. 4.

The constraints 10 allows a user to specify rules defining pricing strategies by site and/or product. The rules take the form of price differentials and ranges which it is desirable are satisfied by prices at an associated retail site 1, 2. Price differentials determine a pricing position of a site relative to other competitor sites within a region. Price differentials are used to indicate a range of acceptable prices for a particular product relative to corresponding competitor prices within which the data engine 8 seeks to determine product prices which satisfy the specified price differentials. Price differentials may provide different ranges of acceptable prices relative to different competitors and in particular may include a differential relative to a main competitor and additionally or alternatively may include a differential relative to a different site in the network of associated retail fuel sites 1, 2, such that pricing at a first site in the network generally follows pricing at a second site in the network.

Price differentials may either be constraint-type differentials indicating constraints on prices that should be satisfied, often relative to a main competitor for a particular site, or guide-type differentials, which are optional constraints that are to be satisfied where possible, but which may be ignored if they cannot be met. Where a guide-type differential is not satisfied by pricing determined for a particular site the site may be added to a list of sites to be manually reviewed, for example by an expert analyst or a manager at an associated retail fuel site 1, 2. Alternatively, rules may be relaxed either manually or automatically such that optimal prices can be determined. That is, where it is determined that all of the currently specified rules cannot be satisfied, one or more of the rules may be made less restrictive. The one or more rules may be selected based upon an order which specifies the order in which rules should be relaxed if all of the rules cannot be satisfied.

The optimisation engine 11 is used to determine a set of prices which maximise some objective, whilst attempting to satisfy the rules specified by the constraints 10. In general terms, price optimisation is concerned with balancing profit with volume sales within specified price constraints. The optimisation engine takes as input a policy which indicates the relative importance of profit and volume sales for the optimisation and may be provided as a value between 0 and 100 where 0 indicates that profit is to be maximised and 100 indicates that volume is to be maximised, and values between 0 and 100 indicate relative proportions of profit and volume maximisation. The optimisation engine 11 may additionally be provided with data indicating information about the current market environment which can be taken into account in the generation of prices such as, for example data indicating expected variation in sales in a region or network. Examples of additional information may include data indicating that an event caused a reduction of sales on a particular day, or that a forthcoming event is likely to cause high sales such that strategy should be modified, for example to maximise profit.

The data engine 8 uses the demand model 9, constraints 10 and optimisation engine 11 to generate a recommended price 12 for each product at each associated retail fuel site 1, 2 in the network of associated retail fuel sites using modelling techniques well known in the art. For example, sequential quadratic programming, active set solvers, interior point solvers or other suitable non-linear optimisation techniques may be used to generate the recommended price 12. Additionally, a daily error-correction process such as a Kalman filter or dynamic linear model may be used to update model parameters in light of prediction errors. The data engine 8 may additionally provide output data 13 which can be used to predict competitor price changes, and to understand competitor pricing policies. Data 14 is generated indicating constraints which are specified by the constraints 10 but which are not satisfied by the recommended price 12. Reports 15 may also be generated by the data engine 8. The output data may be provided to the associated retail site 1, 2 in any convenient way, for example using the same method as that used to provide retail site and competitor data to the pricing system 7 from the retail site.

Referring now to FIG. 2A, a schematic functional block diagram of the pricing system is shown. The system has three functional blocks 101, 104, 105 which each take data as input, both from external sources and additionally from others of the three functional blocks, and each generate output data.

In more detail, a sales prediction block 101 takes as input own prices 102 and competitor prices 103 together with an updated model generated at a learning and updating block 104, and outputs expected sales for the current period. The expected sales output from the sales prediction block 101 are input to an optimisation generation block 105 which also takes as input site level volume constraints 106 (indicating minimum required volume sales for a site), price constraints 107 and costs 108. The optimisation generation block processes its inputs and generates a set of optimal prices and a corresponding forecast of sales, the forecast of sales being based upon the generated set of optimal prices. The forecast of sales and the optimal prices output from the optimisation generation block 105 is input to the learning and updating block 104, together with achieved sales during the period for which the optimal prices were generated and used. The updated model that is passed to the sales prediction block 101 is generated at the learning and updating block 104 based upon the forecast sales for the period and the achieved sales for the period. In this way, the sales prediction for the next period is improved.

The optimal prices for an associated retail fuel site i, generated at the optimisation generation block 105 of FIG. 2A, can be determined by solving an optimisation problem of the form shown in equation (1):

$$maximise {\sum }_{i = 1}^{m} {\sum }_{k = 1}^{p} {G}_{tik} \qquad ( 1 )$$

with respect to own prices: {Pₜᵢₖ}_{i=1 . . . m,k=1 . . . p};

subject to price constraints: {g₁_{ᵢₖ}≧0}ₗ_{ᵢₖ}_{=1 . . . q}_{ᵢₖ}_{,i=1 . . . m,k=1 . . . p}; and

site level volume constraints:

$${\{ {\sum }_{k} {V}_{tik} \geq {L}_{ti} \}}_{i = 1 … m}$$

where:
is an index indicating an ith one of m associated retail fuel sites;
j is an index indicating a jth one of n competitor sites;
k is an index indicating a kth one of p fuel products;
t is a time period;
Gₜᵢₖ indicates gross profit from sale of grade k at site i in time period t and can be modelled in the form shown below in equation (3);
Pₜᵢₖ indicates the current price of fuel product k at associated retail fuel site i and time t;
lᵢₖ is an index indicating an lᵢₖth one of qᵢₖ price constraints indicating constraints on price such as a constraint on price difference between own and competitor products for a particular fuel product k;
gₗ_{ᵢₖ} models the qᵢₖ price constraints as a linear function of own price, cost and competing prices for site i and fuel product k and has the form shown in equation (4) below;
Vₜᵢₖ indicates sales volume in time period t at site i for grade k and can be modelled in the form shown below in equation (2); and
Lₜᵢ indicates a minimum volume target for sales in time period t at site i.

Sales volume can be modelled in the form shown in equation (2):

Vₜᵢₖ=f(Vₛᵢₖ,Pₜᵢₖ,Pₜⱼₖ) (2)

where:
Vₛᵢₖ indicates previous sales at a time s<t;
Pₜⱼₖ indicates the current price of fuel product k at competitor retail fuel site j and time t; and
f is a model describing the relationships (referred to as elasticities) between own prices and competitor prices, based upon previous sales Vₛᵢₖ and generally is a log-log or log-linear model. The coefficients of the price terms of f are price elasticities. Further details of the form and estimation of the model can be found in, for example the following, which are herein incorporated by reference: Singh, M. G., Bennavail, J.-C, (1993) “Experiments in the use of a knowledge support system for the pricing of gasoline products”, Information & Decision Technologies 18(6): 427-442; Krasteva, E., Singh, M. G., Sotirov, G., Bennavail, J.-C., and Mincoff, N., (1994) “Model Building for pricing decision making in an uncertain environment, Proc. IEEE International Conference on Systems, Man and Cybernetics”, San Antonio; and Bitran, G., Caldentey, R. and Mondeschein, S. (1998) “Coordinating clearance markdown sales of seasonal products in retail chains”, Operations Research 46(5): 609-624.

Accordingly gross profit Gₜᵢₖ can be modelled as shown in equation (3):

$${G}_{tik} = ( \frac{{P}_{tik}}{1 + v} - {C}_{tik} ) {V}_{tik} = ( \frac{{P}_{tik}}{1 + v} - {C}_{tik} ) f ( {V}_{sik} , {P}_{tik} , {P}_{tjk} ) \qquad ( 3 )$$

where:
Pₜᵢₖ indicates current price of fuel product k at site i and time t as above;
Cₜᵢₖ indicates direct sales costs for fuel product k in time period t at site i; and
v is the applicable sales tax rate.

The price constraints gₗ_{ᵢₖ} can be modelled in the form shown in equation (4):

gₗ_{ᵢₖ}(Pₜᵢₖ,Cₜᵢₖ,Pₜⱼₖ)≧0 (4)

where Pₜᵢₖ, Cₜᵢₖ and Pₜⱼₖ are as described above.

The optimisation problem of equation (1) can be solved using non-linear optimisation techniques well known in the art such as those described in Gill, P. E., Murray, W., and Wright, M. H., “Practical Optimisation” (1981), Academic Press, which is herein incorporated by reference. The optimisation provides a set of prices Pₜᵢₖ, indicating an optimal price at each site for each fuel product given various constraints that are applicable at the current time t.

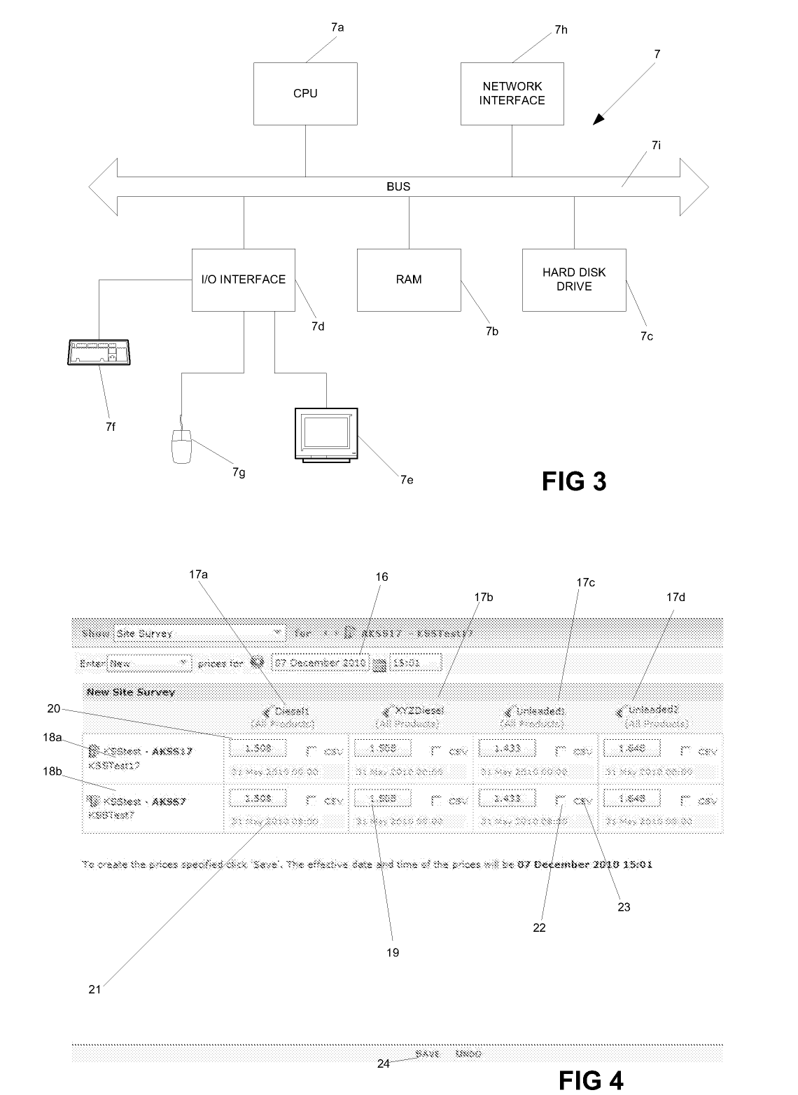

FIG. 3 shows a computer associated with the pricing system 7 of the system of FIG. 1 in further detail. It can be seen that the computer associated with the pricing system comprises a CPU 7a which is configured to read and execute instructions stored in a volatile memory 7b which takes the form of a random access memory. The volatile memory 7b stores instructions for execution by the CPU 7a and data used by those instructions. For example, in use, software used to determine optimal prices for retail fuel sites may be stored in volatile memory 7b.

The computer associated with the pricing system 7 further comprises non-volatile storage in the form of a hard disc drive 7c. Data such as retail fuel site data and competitor site data may be stored in the hard disc drive 7c. The computer associated with the pricing system 7 further comprises an I/O interface 7d to which are connected peripheral devices used in connection with the computer associated with the pricing system 7. The computer associated with the pricing system 7 has a display 7e configured so as to display output from the data engine. Input devices are also connected to the I/O interface 7d. Such input devices include a keyboard 7f, and a mouse 7g which allow user interaction with the data engine. A network interface 7h allows the computer associated with the pricing system 7 to be connected to an appropriate computer network so as to receive and transmit data from and to other computing devices such as computing devices provided at the retail fuel sites. The CPU 7a, volatile memory 7b, hard disc drive 7c, I/O interface 7d, and network interface 7h, are connected together by a bus 7i.

It has been indicated above that associated retail fuel site and competitor site prices are provided to the pricing system 7. Referring to FIG. 4, a user interface suitable for inputting product prices for a site and its competitors is shown. The time and date for which the data applies is provided using date and time fields 16. Headers 17a, 17b, 17c and 17d indicate different products available at the site for which data is to be entered. A row 18a provides data display and entry for an associated retail fuel site “AKSS17” and a row 18b provides data entry and display for a competitor retail fuel site. Other rows may be provided to provide data entry and display for further competitor retail fuel sites, as determined from the model defining interrelationships between the sites.

Price fields 19, 20 provide editable fields in which price data associated with each product and site is entered and/or displayed. For example, price field 19 provides a field in which price data for product “Diesel1” at site “AKSS17” is entered and displayed and price field 20 provides a field in which price data for product “XYZDiesel” at site “AKSS7” is entered and displayed. Price fields 19, 20 may be provided with associated logic which defines maximum and minimum values. Each price field 19, 20 has an associated time and date stamp 21 which indicates the time and date of the last change to the price displayed in the time and date field. A check box 22 associated with each price field 19, 20 allows a user of the user interface to select whether the input data should be updated in the pricing system 7 and a price entry marker 23 associated with each price field 19, 20 indicates the source of the displayed value. The source of the displayed value may be one of user entered, entered following site survey, file input, entered via error browser or set by pricing system. Upon selection of a “save” button 24 data that has been entered into the user interface is submitted to the data engine, and in particular values in the demand model are updated.

In some embodiments the output data may be used to cause automatic update of optimal fuel prices at the associated retail fuel sites 1, 2, for example by providing data to a computer located at the associated retail fuel sites 1, 2 which is in communication with pumps, tills and signage at the associated retail fuel sites. Where automatic update of optimal fuel prices is used, it is generally necessary to carry out the update at a time when the associated retail fuel sites 1, 2 are not operational. However in general output data is provided to the associated retail fuel sites 1, 2 and fuel prices are changed by way of at least some manual intervention. For example, a manager of each associated retail fuel site 1, 2 may receive at least some of the output data generated by the pricing system 7 and may then decide what fuel price changes to implement.

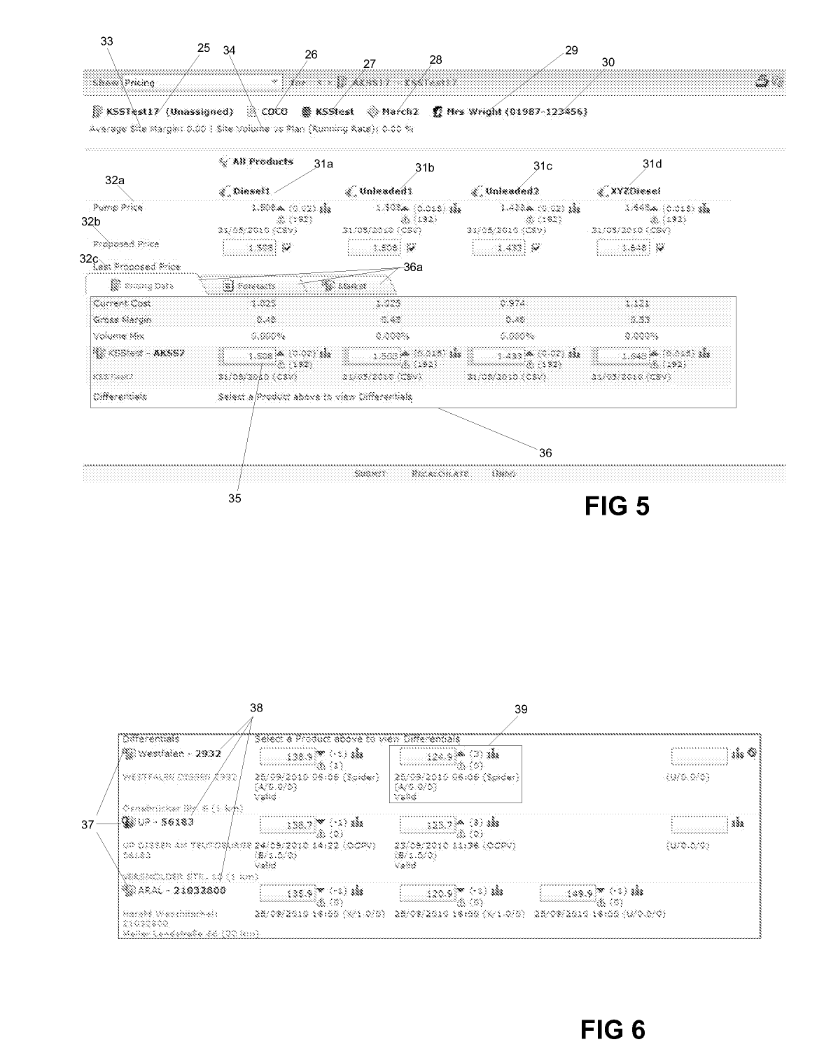

As indicated above, various output data relevant to each site is generated and provided to associated retail fuel sites 1, 2. The output data provided to each site may be displayed on a pricing page which provides data relevant to the particular retail fuel site such as the pricing page of FIG. 5. For example, the pricing page may display site details including the name of the site 25, contract type 26, brand 27, area 28, area manager name 29 and contact number 30 associated with the retail fuel site. Headers 31a, 31b, 31c and 31d indicate different products available at the site and data relevant to each product is displayed in columns beneath each header. The data relevant to each product includes pump price data displayed in a row indicated by header 32a which is described in further detail below with reference to FIG. 6, a proposed price field displayed in a row indicated by header 32b which includes an editable price field into which price changes can be entered and a check box which indicates whether an entered price should be updated in the pricing system 7, and a last proposed price displayed in a row indicated by header 32c. Average site margin 33 indicating the average margin across all fuel products at the site is displayed, together with an indication 34 of the percentage running rate indicating the percentage of planned target sales volume in the current planning period that have actually been achieved, where the planned target sales volume is calculated by multiplying the total target sales volume in the current planning period by the proportion of time that has passed in the current planning period.

Additionally, tabs 36a allow a user to selectively display one of further pricing data, forecasts and market data in screen area 36. In FIG. 5 the pricing data tab is selected such that further pricing data is shown. Further pricing data can be seen to include a current cost associated with each product indicating the price paid for the product, a gross margin associated with each product indicating the difference between the current pump price and the current cost and a volume mix indicating total sales for each product available at the site as a percentage of total sales at the site. An editable data field 35 associated with each product allows pump prices to be entered by a user. Upon entering a pump price in the data field 35 the data in screen area 36 is updated based upon the entered pump price to display the effect of a possible pump price allowing a user to consider different pricing strategies. Additionally, price differentials indicating price constraints relative to current and proposed own prices, as shown in rows 32a and 32b respectively, of a particular product may be displayed upon selection of the particular product by selecting one of headers 31a, 31b, 31c, 31d. The price differentials may be displayed in any convenient form, for example as an indication of whether each differential is a maximum or minimum limit, indicating whether own prices should be smaller than or equal to or greater than or equal to the limit value respectively, an indication of the relevant competitor price for the price differential, the limit value and an indication of whether the differential is required or preferred. Where the differential is required it is used as a constraint for the optimisation and where the differential is a guide it is used to test the output of the optimisation for compliance. Where guide differentials are used and are not satisfied, the output is flagged for review.

Selection of the forecasts tab of the tabs 36a causes screen area 36 to display calculated forecast values for each of volume, profit and profit per unit volume for each product based upon the current proposed price for each product together with a change relative to a previous forecast for each of the forecasts. Additionally, a site total across all products is shown for each of forecast volume and forecast profit and their respective changes, and a site average across all products is shown for forecast profit per unit volume together with its respective change.

Selection of the market tab of the tabs 36a causes pricing details of competitor sites to be displayed for each product sold at both the current site (as indicated by the name of the site 25) and competitor sites. It can be noted that competitor prices may also be shown when the pricing data tab is selected upon suitable configuration of the pricing data tab, for example as shown in FIG. 5. FIG. 6 shows data that is displayed in screen area 36 when the market tab is selected. The site for which data is displayed in FIG. 6 has three associated competitor sites “Westfalen”, “UP” and “Aral” indicated by competitor site markers 37 which are provided with a name associated with the site. The competitor site markers 37 provide information relating to the available data for the competitor site. For example, a symbol such as an exclamation mark may be used to indicate that data is missing for the competitor site, and different colors for the competitor site markers 37 may be used to indicate properties such as a missing price for which a price differential is set. For each competitor site, data is provided beneath the competitor site marker 37 indicating an address of the site and an indication of the distance of the competitor site from the associated retail site for which data is currently shown. Additionally, for each competitor site a data import code 38 is displayed in bold, which provides a code for the competitor site for importing data.

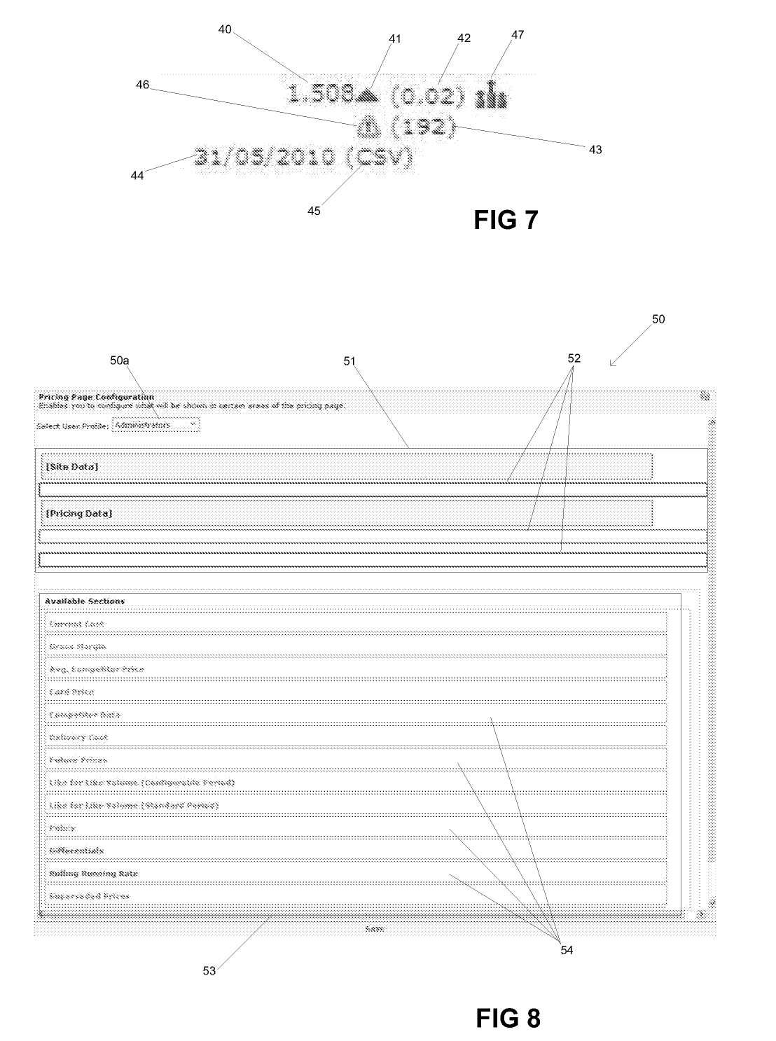

Pump price data, as described below with reference to FIG. 7, is displayed for each competitor and product as indicated by headers 31a, 31b, 31c, 31d in FIG. 5 and by competitor site markers 37. That is, each pump price data, one of which is shown in box 39, is in a row which indicates a competitor site associated with the pump price data and a column which indicates a product associated with the pump price data. Where the display area for pump price data for a particular product and competitor site is blank, the product is known to not be available at that site. Where the display area contains fields for pump price data but the fields are not populated, no data is currently available.

An example pump price data displayed for product “Diesel1” of FIG. 5 is shown in FIG. 7. It will be appreciated that competitor pump price data displayed upon selection of the market tab has the same form. The pump price data includes a current pump price 40 and a price movement indicator 41 which indicates whether the current pump price 40 is higher, lower or equal to the previous pump price. The difference 42 between the current pump price 40 and the previous pump price is also indicated together with the number of days 43 since the last price change. Date stamp 44 indicates the date that the current pump price was last modified and a source stamp 45 indicates how the current pump price was modified such as user entered, entered following site survey, file input, entered via an error browser or set by pricing system. Additionally an icon 46 may be provided to indicate one or all of: the displayed price has not been updated within a predetermined number of days; the displayed price was amended by a user other than the current user; the displayed competitor price is not active, that is, the displayed competitor price is excluded from processing, for example due it not having been validated; the displayed competitor price has been verified by a third party source; and the displayed competitor price cannot be verified by a third part source. Where it is indicated that the displayed competitor price cannot be verified by a third party source, a check box may be displayed which allows a user to verify the price manually. Selection of an icon 47 causes a chart of historic price data and/or sales volume data to be displayed for the relevant item.

The pricing page is configurable such that information may be displayed to a user according to predefined preferences for that user. The predefined preferences may be selected by the user or may be selected for each user on the basis of a property of the user, such as for example the contract type for a retail fuel site associated with the user. In this way, the information that is most relevant and/or useful to the user is provided. The pricing page is configured using a pricing page configuration page 50 as shown in FIG. 8. The pricing page shows a layout that corresponds to the pricing page and allows types of data to be specified in areas of the layout for a particular user such that the specified data is displayed in corresponding areas of the pricing page that is displayed to the user.

Referring now to FIG. 8, the pricing configuration page 50 has a drop down menu 50a which allows a user to select a user profile for which the pricing page is to be configured. The pricing configuration page is generally divided into two display regions for configuring the selected user's pricing page. A pricing page screen area display region 51 displays a plurality of screen area boxes 52, each box corresponding to a distinct screen area of the pricing page in which data items can be displayed such as the screen area 36 shown in FIG. 5. An available data region 53 displays a plurality of text boxes 54, each text box 54 corresponding to a data item that can be configured to be displayed in one of the screen areas of the pricing page, for example the average site margin data 33. The location of text boxes 54 within a screen area box 52 causes the data associated with the text box to be displayed within the corresponding screen area of the pricing page. Additionally, the order of the text boxes 54 within a screen area box 52 indicates the order in which the data is to be displayed within the corresponding pricing page screen area.

Each of the screen area boxes 52 has an associated color indicated by the color of a border of the box and text identifying the screen area of the pricing page with which the box is associated. Text boxes 54 can be dragged and dropped into a screen area box 52 if an associated color of the text box 54 matches the associated color of the screen area box 52. Text boxes 54 can additionally be dragged within screen area boxes 52 to order the text boxes within a screen area.

Various data can be configured to be displayed within screen areas of the pricing page. For example, site details such as a rolling run rate indicating a total achieved volume sales as a percentage of total volume over weighted planning periods, may be displayed in addition to or in place of, for example, percentage running rate 34 shown in FIG. 5. Examples of data that may be displayed in area 36 shown in FIG. 5 in addition to or in place of one or more of the current cost, gross margin, volume mix and price differentials shown in FIG. 5 include: an average competitor price indicating the average price for each product across all competitor sites; a card price indicating the pump price minus a specified discount value; competitor data showing details of competitor sites; a delivery cost indicating a total cost associated with delivering a unit of each fuel product to a customer; a future price indicating details of prices that are to be applied at a predetermined time in the future; like for like volumes indicating volume sales for each product over a predetermined time period as a percentage of volume sales for the product over the same time period in a previous year; a policy for each product indicating a volume sales target for the product; and superseded prices indicating details of prices that have been replaced. The future price for each product may include details of a price to be applied at a time in the future, the time at which the price is applicable and data associated with the origin of the price. Similar details may be provided for superseded prices. It will be appreciated that any other suitable screen area and data field may be configured to either be displayed or to not be displayed, in order to configure the pricing page to different users' requirements.

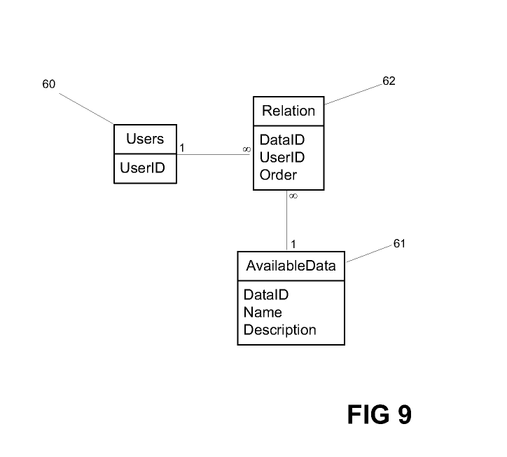

Data associated with the display of data on a pricing page for users may be stored in any convenient form. For example, FIG. 9 is an entity diagram of a database suitable for storing and managing data to be displayed as part of a pricing page for different users. As shown in FIG. 9, the database has three tables: a Users table 60; an AvailableData table 61 and a Relation table 62. Each entry of the Users table 60 is associated with a user of the system, each entry of the AvailableData table 61 is associated with a data item that may be displayed as part of a pricing page and each entry of the Relation table 62 indicates a relationship between a user and a data item, together with an order associated with display of the data item.

The Users table 60 has a UserID field which is its primary key, and may additionally have fields for storing data associated with each user such as a name field. The AvailableData table 61 has a dataID field which is its primary key, a Name field for storing the name of a data item and a Description field for storing a description of the data item. The Relation table 62 has a DataID field which identifies a record of the AvailableData table 61, a UserID field which identifies a record of the Users table 60 and an Order field which defines an order for display of the data item identified by the DataID field relative to other data items to be displayed.

When a pricing page is to be displayed for a particular user a lookup is carried out to identify all records of the Relation table 62 having a UserID corresponding to the UserID of the particular user. The DataID of each identified record identifies a record of the AvailableData table 61 which corresponds to a data item to be displayed as part of the pricing page which can then be displayed to the user.

In some embodiments the data items available to be added for a particular user or group of users may be modified based upon a property of the user or group of users. For example, some users may not be able to view a particular data item as part of the pricing page as the data item may be of a sensitive nature.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A computer-implemented method of displaying fuel price data to a user, the method being implemented in a computer comprising a memory in communication with a processor, the method comprising:
storing, in the memory, a plurality of fuel price data items, each fuel price data item being associated with at least one product and at least one retail fuel location;
receiving, as input to the processor, configuration data associated with said user, said configuration data indicating fuel price data to be displayed to said user;
processing, by the processor, said fuel price data items and said configuration data to determine said fuel price data; and
displaying, on a display device coupled to said computer, said fuel price data based upon said configuration data.

2. A computer-implemented method according to claim 1, wherein said configuration data comprises data indicating layout of said fuel price data to said user.

3. A computer-implemented method according to claim 1, wherein said configuration data comprises data indicating data items to be displayed to said user.

4. A computer-implemented method according to claim 1, wherein processing said fuel price data items and said configuration data to determine said fuel price data comprises:
identifying fuel price data to be displayed based upon said configuration data; and
processing said fuel price data items to determine a value of said fuel price data to be displayed.

5. A computer-implemented method according to claim 1, wherein said displaying comprises displaying a graphical user interface comprising a plurality of graphical user interface regions, and said configuration data determines regions in which respective fuel price data is displayed.

6. A computer-implemented method according to claim 1, wherein determining fuel price data comprises selecting at least one of said plurality of fuel price data items.

7. A computer-implemented method according to claim 1, further comprising storing, in the memory, said configuration data associated with said user.

8. A computer-implemented method according to claim 1, wherein said configuration data associated with said user is generated by:
displaying a plurality of layout indicators, each layout indicator corresponding to one of said fuel price data items;
receiving, input indicating layout of said layout indicators; and
generating said configuration data based upon said input.

9. A computer-implemented method according to claim 8, further comprising:
displaying a configuration graphical user interface, said configuration graphical user interface comprising a plurality of configuration regions, each configuration region corresponding to one of a plurality of graphical user interface regions for displaying said fuel price data;
wherein receiving input indicating layout of said fuel price indicators comprises receiving input caused to arrange at least some of said layout indicators into at least one of said plurality of configuration regions.

10. A computer-implemented method according to claim 9, wherein each of said plurality of configuration regions and each of said plurality of layout indicators has an associated property, said property indicating relationships between said layout indicators and said configuration regions.

11. A computer-implemented method according to claim 10, wherein said property is a colour.

12. A computer-implemented method according to claim 10, wherein said relationship is a relationship indicating that a fuel price data item associated with the layout indicator can be displayed in a graphical user interface region associated with the configuration region.

13. A computer program comprising computer readable instructions configured to cause a computer to carry out a method according to claim 1.

14. A computer readable medium carrying a computer program according to claim 13.

15. A computer apparatus for displaying fuel price data to a user, the apparatus comprising:
a memory storing processor readable instructions; and
a processor arranged to read and execute instructions stored in said memory; wherein said processor readable instructions comprise instructions arranged to control the computer to carry out a method according to claim 1.
